(19) United States
(12) Patent Application Publication
(10) Pub. No.: US 2018/0366257 A1
(43) Pub. Date: Dec. 20, 2018

(54) Use of Thermally Conductive Powders as Heat Transfer Materials for Electrical Components

(71) Applicant: Radyne Corporation, Milwaukee, WI (US)

(72) Inventors: Roberto Bernardo Benedicto OVANDO, Milwaukee, WI (US); Thomas CAHILL, Delafield, WI (US); John Justin MORTIMER, Genesee, WI (US)

(21) Appl. No.: 16/009,853

(22) Filed: Jun. 15, 2018

Related U.S. Application Data
(60) Provisional application No. 62/520,165, filed on Jun. 15, 2017.

(51) Int. Cl. H01F 27/28; H01F 27/32

(52) U.S. Cl. CPC H01F 27/2876; H01F 27/327; H01F 27/2823

(57) ABSTRACT

A cap sealing electric inductor assembly or electric power transformer assembly is formed by encasing a cap sealing electric inductor or an electric power transformer in a thermally conductive powder with a thermal conductivity greater than 30 W/m·K. A heat exchanger array transfers heat from the thermally conductive powder generated by operation of the cap sealing electric inductor or the electric power transformer to ambient.

### CROSS REFERENCE TO RELATED APPLICATIONS

This application claims priority to U.S. Provisional Application No. 62/520,165 filed Jun. 15, 2017, hereby incorporated by reference in its entirety.

### FIELD OF THE INVENTION

The present invention relates to cap sealing electric inductor assemblies formed from cap sealing electric inductors encased in a thermally conductive powder and electric power transformer assemblies used in electric induction material heating and melting apparatus formed from electric power transformers encased in a thermally conductive powder.

### BACKGROUND OF THE INVENTION

Induction sealing, otherwise known as cap sealing or electric induction foil cap sealing, is a non-contact method of induction heating a sealing material over the opening of a container such as the opening of a bottle after filling the bottle with product that will be used at a future time when the sealing material will be removed. The term foil cap sealing is also used since in some cap sealing applications an aluminum foil layer liner is inductively heated to bond a polymer film in the sealing material to the lip of the opening of the bottle or other container.

Since its development in the 1920's, electric induction heating systems have found a countless range of application in manufacturing processes, materials, and food processing as well as in multiple metallurgy practices, among others. In an electric induction industrial or commercial heating application, a variable magnetic field of high frequency heats up an object by means of electromagnetic forces. The variable magnetic field is produced due to the electric current in an electrical conductor that is commonly known as an induction work coil. When an object is exposed to a variable magnetic field, eddy electric currents are induced in the object itself. The magnitude of the eddy electric currents depends on the electrical and the magnetic properties of the object. The eddy electric currents produce Joule power losses that overheat the object. The power losses increase as the magnitude of the electric current and the frequency increases.

On the other hand, the electric current that flows through the induction work coil (also referred to as electrical conductor or inductor) produces Joule power losses in the induction work coil itself. The power losses increase as the resistance of the induction work coil increases. Typically, the resistance of an electrical conductor increases as the temperature of the conductor increases. Therefore, the Joule power losses contribute to the overheating of the induction work coil and to the decrease in the efficiency of the electric induction heating system. Nevertheless, typical induction work coils are built with hollow copper tubing where a cooling flow, commonly water, is injected to avoid the overheating of the induction work coil. Additionally, in low power (for example 5 kW or less) applications, as those implemented in cap sealing applications, the induction work coils are formed with litz wire that can be cooled with the forced flow of a cooling fluid or heat exchangers that require a large surface area of heat dissipation transfer elements (fins) for a sufficient rate of cooling.

At certain frequencies, litz wire has a lower electrical resistance than a solid electrical conductor. The lower electrical resistance of the litz wire contributes to reduce the amount of power losses and overheating of the induction work coil.

In some conventional foil cap sealers litz wire coils are used as the cap sealing inductor and are encapsulated in hard potting materials. Hard potting materials have relatively poor thermal properties. The poor thermal properties of the encapsulation potting materials contribute to the overheating of the induction cap sealing coil. Therefore a more robust cooling system is required to cool down an induction cap sealing coil that has been encapsulated in a hard potting material. Also, induction cap sealing coils that are encapsulated in hard potting materials are more susceptive to mechanical fractures that are produced by thermal stresses and electromagnetic forces.

Abreast of the development of the industrial and commercial induction heating apparatus that are used to heat or melt workpieces, electric transformers have been extensively used and improved to increase the efficiency of the electric power transmission from the power source to the induction work coil. Commonly electric power transformers are used as matching impedance devices in electric induction heating applications to enhance and increase the tuning capabilities of the system's power sources with the induction load, for example, a cap sealing, welding or soldering induction coil. A typical electric power transformer is formed with windings in the shape of circular cables, solid conductors and/or cylindrical shaped conductors that are wrapped and lumped around a shell form magnetic core.

In an electric power transformer the Joule power losses in the windings, as well as eddy current and the hysteresis losses from the magnetic core, increase as the frequency of the electric induction heating system's power source increases. The power losses produce overheating and hot spots that impact negatively on the performance of the electric power transformer. To avoid overheating damages, ordinary cooling apparatus implement the injection and/or the immersion of the entire transformer unit or assembly in a cooling fluid, which is generally mineral oil or water.

Water cooling and fan systems require the implementation of auxiliary equipment and movable parts such as water connectors, water pumps, fan blades and motors, among other components, that contribute to an increase in the overall volume and weight of the electric induction heating system and also complicates cleaning and maintenance procedures for a cap sealing electric inductor or an electric power transformer used in an electrical induction heating system.

U.S. Pat. No. 6,713,735 B2 discloses one example of an induction foil cap sealer with separately mounted sealing head module and power supply module where both modules are convection air-cooled and heat pipes are used to transfer heat from the sealing head module.

U.S. Pat. No. 4,343,989 discloses a cast magnesium based structure as a heat storage material.

It is an object of the present invention to provide a cap sealing electric inductor assembly with improved thermal dissipation and mechanical performance.

It is another object of the present invention to provide an electric power transformer assembly with improved thermal dissipation as used in electrical induction heating apparatus, for example, where the application is cap sealing, welding or soldering.

### BRIEF SUMMARY OF THE INVENTION

In one aspect the present invention is a cap sealing electric inductor assembly formed from a cap sealing electric inductor encased in a thermally conductive powder either in direct contact with the cap sealing electric inductor or contained in a non-metallic thermally conductive powder enclosure conformed to the outer shape of the cap sealing electric inductor with the thermally conductive powder in direct or indirect heat transfer contact with a heat exchanger array to transfer heat generated by operation of the cap sealing electric inductor to ambient.

In another aspect the present invention is an electric power transformer assembly in an industrial electric induction workpiece heating application where the electric power transformer assembly is formed from an electric power transformer encased in a thermally conductive powder either in direct contact with the electric power transformer or contained in a non-metallic thermally conductive powder enclosure conformed to the outer shape of the electric power transformer with the thermally conductive powder in direct or indirect heat transfer contact with a heat exchanger array to transfer heat generated by operation of the electric power transformer to ambient.

The above and other aspects of the invention are set forth and described in the present specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims.

FIG. 1(a) diagrammatically illustrates one example of a cap sealing electric inductor assembly of the present invention.

FIG. 1(b) diagrammatically illustrates one example of an electric power transformer assembly of the present invention.

FIG. 2(a) is an exploded perspective view of one example of a cap sealer assembly in a cap sealing electric induction apparatus with a cap sealing electric inductor assembly and an electric power transformer assembly of the present invention.

FIG. 2(b) is a top view of the cap sealer assembly in FIG. 2(a) when assembled.

FIG. 2(c) is a cross-sectional view of the assembled cap sealer assembly in FIG. 2(b) with sectioning plane defined by line A-A in FIG. 2(b).

FIG. 2(d) is a cross-sectional view of another embodiment of a cap sealer assembly with a cap sealing electric inductor assembly and an electric power transformer assembly of the present invention.

FIG. 3 is one example of a heat pipe assembly that is the heat exchanger array in an example of a cap sealing electric inductor assembly and an electric power transformer assembly of the present invention.

### DETAILED DESCRIPTION OF THE INVENTION

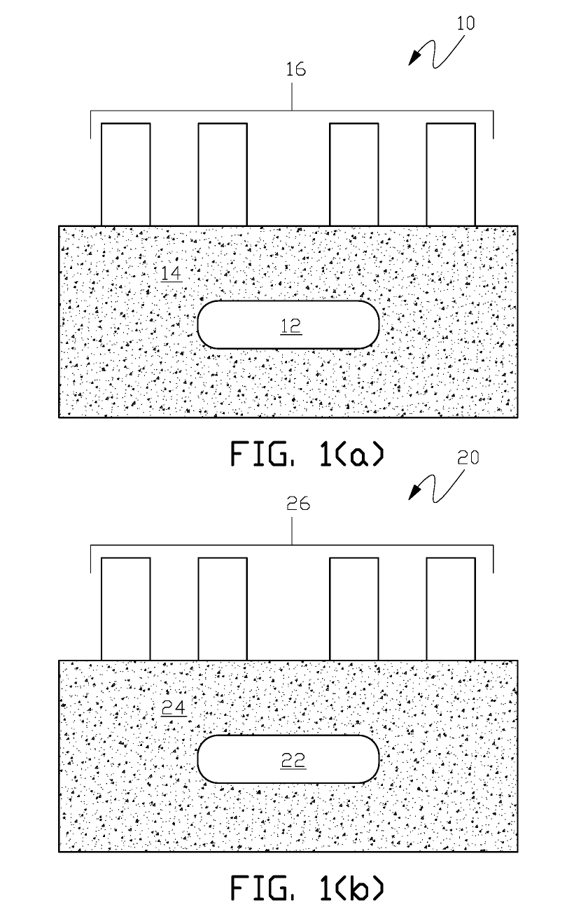

There is shown in FIG. 1(a) one embodiment of a cap sealing electric inductor assembly 10 of the present invention. Cap sealing electric inductor 12 is encased in a thermally conductive powder 14 having a thermal conductivity greater than 30 watts per meter-kelvin (W/m·K), which powder is configured for direct or indirect heat transfer contact with the outer surface area of cap sealing electric inductor 12. A heat exchanger array 16 is configured for direct or indirect heat transfer contact with the thermally conductive powder 14 to transfer heat generated by operation of cap sealing electric inductor 12 from the thermally conductive powder 14 to ambient by convection and radiation, for example, with a conventional active or passive heat exchanger, for example, a heat sink where the heat absorbing element is alternatively: embedded in the thermally conductive powder; adjacent to a surface of the thermally conductive powder; or indirectly in heat transfer contact with the thermally conductive powder, for example, via an intervening thermally conductive material, and the transferred heat dissipation element (for example fins) of the heat exchanger is located in ambient.

The cap sealing electric inductor 12 in various embodiments of the invention is formed as a single or a plurality of induction coils, cables or litz wire configured as a cap sealing electric inductor assembly in a cap sealing electric induction apparatus.

There is shown in FIG. 1(b) one embodiment of an electric power transformer assembly 20 of the present invention configured for an electric induction heating apparatus, for example, where the application is cap sealing, welding or soldering. Electric power transformer 22 is encased in a thermally conductive powder 24 having a thermal conductivity greater than 30 W/m·K, which powder is configured for direct or indirect heat transfer contact with the outer surface area of electric power transformer 22. A heat exchanger array 26 is configured for direct or indirect heat transfer contact with the thermally conductive powder 24 to transfer heat generated by operation of electric power transformer 22 from the thermally conductive powder 24 to ambient by convection and radiation, for example, with a conventional active or passive heat exchanger, for example, a heat sink where the heat absorbing element is alternatively: embedded in the thermally conductive powder; adjacent to a surface of the thermally conductive powder; or indirectly in heat transfer contact with the thermally conductive powder, for example, via an intervening thermally conductive material, and the transferred heat dissipation element (for example fins) of the heat exchanger is located in ambient.

The electric power transformer 22 in various embodiments of the invention comprises transformer windings and one or more magnetic cores as known in the art.

In some embodiments of the invention the thermally conductive powder is contained in a non-electrically conductive powder enclosure that conforms to the outer surface area of the cap sealing electric inductor or the electric power transformer to encase the inductor or transformer, which configuration achieves uniform heat conduction from operation of the cap sealing electric inductor or the electric power transformer to the environment (ambient) external from the cap sealing electric induction apparatus or the electric induction heating application in which the cap sealing electric inductor or electric power transformer is installed.

In some embodiments of the invention if the thermally conductive powder also has a high electrical resistivity, for example when the thermally conductive powder is a magnesium oxide powder composition, the thermally conductive powder is applied directly to the outer surface area of the cap sealing electric inductor to encase the inductor without producing additional Joule power losses that can occur when, for example, conventional aluminum based thermally conductive inductor encapsulants are used. If the thermally conductive powder is also used in an application where the cap sealing electric inductor or the transformer windings have an outer (dielectric) insulation applied to the inductor (for example formed from cables or litz wires) or the windings, the outer electrical insulation can be eliminated and replaced with the thermally conductive powder applied directly to the outer surface area of the cap sealing electric inductor or windings to encase the inductor or windings with improved thermal contact and heat transfer between the cables, wires or windings and a weight reduction of the assembly.

In some embodiments of the invention a heat transfer array 16 or 26 is a heat sink as known in the art, with the heat absorption element in thermal contact with the exterior of a powder enclosure, if used in a particular application, with the transferred heat dissipation element of the heat exchanger located in ambient. In other embodiments of the invention the heat sink is in direct contact with the thermally conductive powder either within a powder enclosure or the thermally conductive powder in direct contact with the cap sealing electric inductor on the electric power transformer with heat transfer surface to ambient.

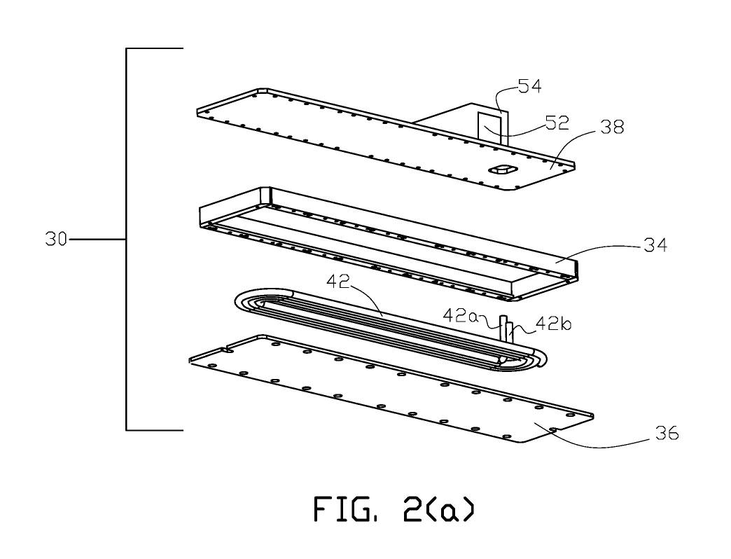

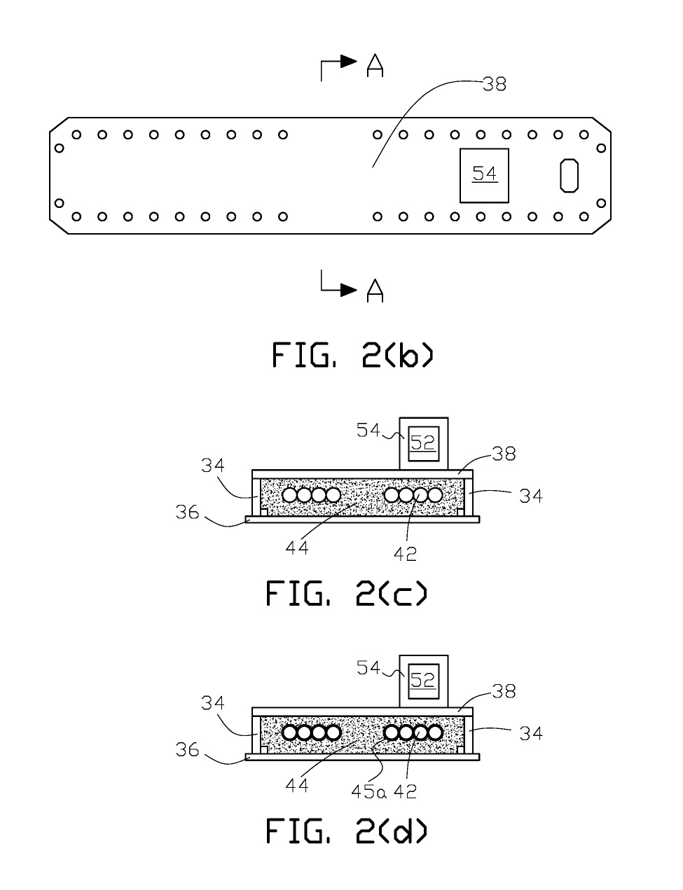

FIG. 2(a), FIG. 2(b) and FIG. 2(c) illustrate one embodiment of a cap sealer assembly in a cap sealing electric induction apparatus where a cap sealing electric inductor assembly and an electric power transformer assembly of the present invention are used, for example, where the induction foil cap sealer disclosed in U.S. Pat. No. 6,713,735, which is incorporated herein by reference in its entirety, is modified for the present invention.

Cap sealer assembly 30, shown in exploded view in FIG. 2(a), when assembled as shown in FIG. 2(c), comprises cap sealing electric inductor 42 (also referred to as an induction coil) encased in direct contact with thermally conductive powder 44 (shown as stippled region) in FIG. 2(c) with an outer powder enclosure formed in this example from: a non-electrically conductive frame 34 disposed around the sides of the cap sealing electric inductor 42 encased in thermally conductive powder 44; lower cover plate 36, which closes the inductor opening within frame 34 and can be formed in this example of the invention from a suitable high temperature plastic or other non-electrically conductive material; and top powder encased inductor plate 38, which attaches to the top perimeter of frame 34 and in this example of the invention is formed from a suitable thermally conductive material such as aluminum.

In the example of the invention shown in the drawings, top powder encased inductor plate 38 provides physical containment and protection of inductor 42 encased in thermally conductive powder 44. The frame, lower cover plate and top powder encased inductor plate form an exterior powder enclosure for the inductor encased in thermally conductive powder 44. The detailed form and configurations of these components will vary as the shape and type of the inductor varies for a particular application. As illustrated in cross section of the assembled cap sealer assembly 30 in FIG. 2(c) thermally conductive powder 44 surrounds and (in direct contact with the inductor) encases inductor 42 in this example of the assembled cap sealing electric inductor assembly.

In other embodiments of the invention where the inductor is formed from one or more induction coils and the thermally conductive powder is in direct contact with the induction coils, the induction coils are provided without outer dielectric insulation and the thermally conductive powder is configured for electrical insulation between the induction coils without outer electrical insulation. Other types of air-cooled inductors with suitable current densities and heat dissipation rates can also be used in other embodiments of the invention.

In other embodiments of the invention the exterior powder enclosure is extended to around the outer surface area of inductor 42 with inner powder boundary enclosure region 45a comprising a thermally conductive non-metallic material so that the thermally conductive powder is contained in a non-metallic thermally conductive powder enclosure that conforms to the outer surface area of cap sealing electric induction coil 42 for an embodiment of the invention where the cap sealing electric inductor in indirect contact with the thermally conductive powder in the non-metallic thermally conductive powder enclosure.

In other examples of the invention cap sealing electric inductor 42 is formed from litz wire with the thermally conductive powder providing electrical insulation between the multiple strands comprising a litz wire or the exterior electrical insulation of each litz wire in applications where the inductor is formed from multiple litz wire.

In some embodiments of the invention shown in the drawings the upper side of top powder encased inductor plate 38 provides a location for: mounting electrical components associated with inductor 42, such as electric power transformer 52 and a capacitor for tuning an LC circuit formed by the inductor and the capacitor; connecting components that may be required for electrical conductors from a cap sealing apparatus power supply (not shown); and connecting means for the terminating ends 42a and 42b of inductor 42 to components mounted on the top powder encased inductor plate 38.

In some embodiments of the invention, as shown in the drawings, electric power transformer 52 is mounted on the upper surface of top powder encased inductor plate 38 as shown in FIG. 2(a) through FIG. 2(c) or alternately FIG. 2(d) and encased (either directly or indirectly) in a thermally conductive powder 54, which is directly or indirectly connected to a heat exchanger array (not shown in the figure).

In embodiments of the invention where the windings of the electric power transformer are formed from insulated wires or cables and the thermally conductive powder is in direct contact with the windings of the transformer, the wires or cables are provided without outer dielectric insulation and the thermally conductive powder is configured for electrical insulation between the wires or cables without outer electrical insulation.

In other examples of the invention electric power transformer 52 is formed from litz wire with the thermally conductive powder providing electrical insulation between the multiple strands comprising a litz wire or the exterior electrical insulation of each litz wire in applications where the inductor is formed from multiple litz wire.

In some embodiments of the invention shown in FIG. 2(a) to FIG. 2(c) or alternatively FIG. 2(d), the heat exchanger array is an active or passive heat exchanger, for example, a heat sink with its heat absorption element in thermal contact with thermally conductive top powder encased inductor plate 38 and with its transferred heat dissipation element disposed in ambient so that the heat sink is in indirect thermal contact with thermally conductive powder 44. In other embodiments of the invention shown in FIG. 2(a) to FIG. 2(c) or alternatively FIG. 2(d) top powder encased inductor plate 38 is not used and the heat absorption element of the heat sink is placed in direct thermal contact with thermally conductive powder 44 in place of the top powder encased inductor plate or embedded in the thermally conductive powder 44.

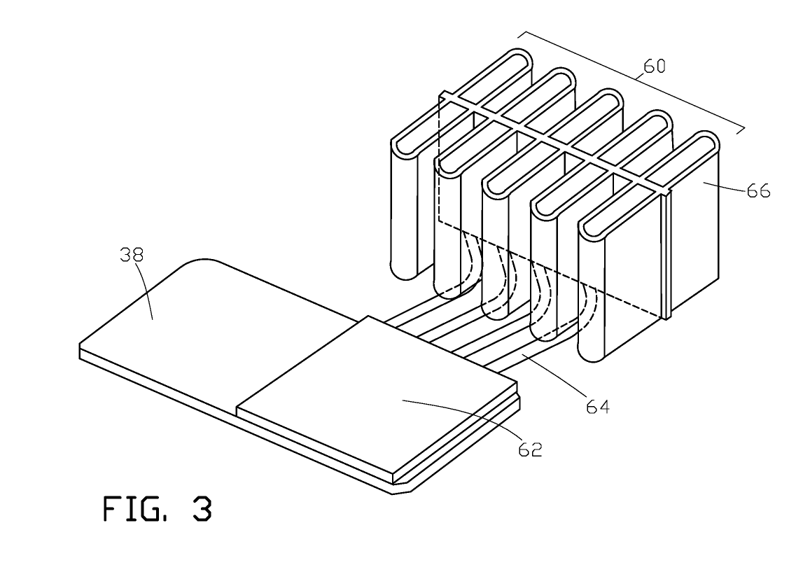

One example of a heat exchanger array used in some embodiments of the invention is shown in FIG. 3. Evaporator elements 62 of one or more heat pipes 60 are placed in close contact with top powder encased inductor plate 38 shown in FIG. 2(a) to FIG. 2(c) or alternatively FIG. 2(d) in one example of the present invention. Heat created in inductor 42 is conducted to thermally conductive powder 44 through top powder encased inductor plate 38 and to evaporator elements 62 of the heat pipe assembly. Inductor 42 generates heat when operating with alternating current flowing through the inductor. As mentioned above in this embodiment of the invention top powder encased inductor plate 38 serves as a thermally conductive material so that the heat exchanger array (heat pipe assembly) is in indirect heat transfer contact with the thermally conductive powder 44 in this example of the invention.

In other examples of the invention, top powder encased inductor plate 38 is not used and is replaced by evaporator elements 62 as a section of the external powder enclosure, or alternatively embedded in the thermally conductive powder, so that the heat exchanger array is in direct heat transfer contact with thermally conductive powder 44 to remove heat from the powder to ambient at the one or more condenser elements 66. The heat transfer fluid, such as a water-based fluid or other suitable liquid, contained within the sealed evaporator elements 62 absorbs the heat. Each connecting tube 64 has one end of its interior passage connected to the sealed interior of an evaporator element, and the opposing end connected to the sealed interior of a condenser element 66. The connecting tube 64 serves as a connector that provides a path for the heat transfer fluid from an evaporator element to a condenser element. The heated fluid moves through the one or more connecting tubes 64 to the one or more condenser elements 66 in which the transfer fluid radiates heat to the surrounding ambient environment, which is generally air within a normal room temperature range.

In other examples of the invention, the heat absorbing element of the heat exchanger array, for example, the evaporator elements 62 in FIG. 3 are embedded within the thermally conductive powder 44 with or without top powder encased inductor plate 38.

A preferable thermally conductive powder for the present invention is a powder composition with a thermal conductivity of greater than 30 W/m·K, for example, a magnesium oxide power composition refined to a thermal conductivity greater than 30 W/m·K or another powder composition with a thermal conductivity greater than 30 W/m·K.

Selected thermally conductive powders, such as magnesium oxide, have a secondary benefit of eliminating thermal stress fractures and fractures from electromagnetic forces in a cap sealing electric inductor or an electric induction power transformer when compared with conventional hard potting materials.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A cap sealing electric inductor assembly comprising:
a cap sealing electric inductor;
a thermally conductive powder having a thermal conductivity greater than 30 W/m·K and configured for encasing the cap sealing electric inductor either by a direct contact of the thermally conductive powder with the outer surface area of the cap sealing electric inductor or by an indirect contact with the thermally conductive powder in a non-metallic thermally conductive enclosure conforming to the outer surface area of the cap sealing electric inductor; and
a heat exchanger array either in direct or indirect heat transfer contact with the thermally conductive powder, the heat exchanger array configured to transfer heat generated by electrical operation of the cap sealing electric inductor from the thermally conductive powder to ambient.

2. A cap sealing electric inductor assembly of claim 1 wherein the thermally conductive powder is contained within an exterior powder enclosure in which the cap sealing electric inductor is encased and the heat exchanger array is in indirect heat transfer contact with the thermally conductive powder via a thermally conductive section of the exterior powder enclosure.

3. A cap sealing electric inductor assembly of claim 2 wherein the exterior power enclosure further comprises the non-metallic thermally conductive enclosure conforming to the outer surface area of the cap sealing electric inductor.

4. A cap sealing electric inductor assembly of claim 1 wherein the thermally conductive powder is contained within an exterior powder enclosure in which the cap sealing electric inductor is encased and a heat absorbing element of the heat exchanger array comprises a section of the exterior powder enclosure in direct heat transfer contact with the thermally conductive powder in the exterior powder enclosure.

5. A cap sealing electric inductor assembly of claim 4 wherein the exterior power enclosure further comprises the non-metallic thermally conductive enclosure conforming to the outer surface area of the cap sealing electric inductor.

6. A cap sealing electric inductor assembly of claim 1 wherein the thermally conductive powder is contained within an exterior powder enclosure in which the cap sealing electric inductor is encased and a heat absorbing element of the heat exchanger array is embedded in the exterior powder enclosure in direct heat transfer contact with the thermally conductive powder in the exterior powder enclosure.

7. A cap sealing electric inductor assembly of claim 1 wherein the heat exchanger array comprises a heat pipe assembly.

8. A cap sealing electric inductor assembly of claim 1 wherein the thermally conductive powder comprises a magnesium oxide composition.

9. A cap sealing electric induction coil assembly of claim 1 wherein the cap sealing electric inductor is formed from one or more litz wires.

10. A cap sealing electric induction coil assembly of claim 9 wherein an electrical insulation between each of a multiple strands in the one or more litz wires is formed by the thermally conductive powder.

11. A cap sealing electric induction coil assembly of claim 1 wherein the cap sealing electric inductor is formed from a plurality of litz wires and an electrical insulation between each of the plurality of litz wires is formed by the thermally conductive powder.

12. An electric power transformer assembly comprising:
an electric power transformer;
a thermally conductive powder having a thermal conductivity greater than 30 W/m·K and configured for encasing the electric power transformer either by a direct contact of the thermally conductive powder with the outer surface area of the electric power transformer or by an indirect contact with the thermally conductive powder in a non-metallic thermally conductive enclosure conforming to the outer surface area of the electric power transformer; and
a heat exchanger array either in direct or indirect heat transfer contact with the thermally conductive powder, the heat exchanger array configured to transfer heat generated by electrical operation of the electric power transformer from the thermally conductive powder to ambient.

13. The electric power transformer assembly of claim 12 wherein the windings of the electric power transformer are formed from one or more litz wires.

14. An electric power transformer assembly of claim 13 wherein an electrical insulation between each of a multiple strands in the one or more litz wires is formed by the thermally conductive powder.

15. An electric power transformer assembly of claim 12 wherein the windings of the electric power transformer are formed from a plurality of litz wires and an electrical insulation between each of the plurality of litz wires is formed by the thermally conductive powder.

16. An electric power transformer assembly of claim 12 wherein the thermally conductive powder is a magnesium oxide composition.

17. A cap sealing electric induction apparatus comprising:
a cap sealing electric inductor assembly comprising:
a cap sealing electric inductor;
an inductor thermally conductive powder having a thermal composition greater than 30 W/m·K and configured for encasing the cap sealing electric inductor either by a direct contact of the inductor thermally conductive powder with the outer surface area of the cap sealing electric inductor or by an indirect contact with the inductor thermally conductive powder in an inductor non-metallic thermally conductive enclosure conforming to the outer surface area of the cap sealing electric inductor; and
an inductor heat exchanger array either in direct or indirect heat transfer contact with the inductor thermally conductive powder, the inductor heat exchanger array configured to transfer heat generated by electrical operation of the cap sealing electric inductor from the inductor thermally conductive powder to ambient; and
an electric power transformer assembly comprising:
an electric power transformer;
a transformer thermally conductive powder having a thermal composition greater than 30 W/m·K and configured for encasing the electric power transformer either by a direct contact of the transformer thermally conductive powder with the outer surface area of the electric power transformer or by an indirect contact with the transformer thermally conductive powder in a transformer non-metallic thermally conductive enclosure conforming to the outer surface area of the electric power transformer; and
a transformer heat exchanger array either in direct or indirect heat transfer contact with the transformer thermally conductive powder, the transformer heat exchanger array configured to transfer heat generated by electrical operation of the electric power transformer to ambient.
